(19) United States
(12) Patent Application Publication
(10) Pub. No.: US 2018/0230969 A1
(43) Pub. Date: Aug. 16, 2018

(54) METHODS AND SYSTEMS FOR WIND FARM FREQUENCY CONTROL

(71) Applicant: Leeward Asset Management, LLC, Dallas, TX (US)

(72) Inventor: Hector M. FIGUEROA, Dallas, TX (US)

(21) Appl. No.: 15/890,830

(22) Filed: Feb. 7, 2018

Related U.S. Application Data
(60) Provisional application No. 62/457,283, filed on Feb. 10, 2017.

(51) Int. Cl. F03D 7/04; H02J 3/38; F03D 7/02

(52) U.S. Cl. CPC F03D 7/048; F03D 17/00; F03D 7/0284; H02J 3/386

(57) ABSTRACT

The present disclosure generally relates to methods and systems for controlling the output frequency of a wind farm by providing instructions for adjusting wind farm output frequency from a frequency controller to an Active Power (AP) Controller in an existing SCADA system. More specifically, the method generally includes receiving frequency data of a plurality of wind turbines collected at a Point of Interconnection (POI) of a wind farm, calculating an error value based on a comparison of the frequency data to a predetermined frequency set point, determining whether to increase, decrease, or not affect an output frequency of the wind farm based on analysis of the calculated error value, and transmitting to an AP controller the determination whether to increase, decrease, or not affect the output frequency.

### CROSS-REFERENCE TO RELATED APPLICATIONS

This application claims benefit of U.S. Provisional Patent Application Ser. No. 62/457,283, filed on Feb. 10, 2017, which is herein incorporated by reference in its entirety.

### BACKGROUND

### Field

The present disclosure generally relates to controlling wind farms, and more particularly to methods and systems for controlling wind farm output frequency.

### Description of the Related Art

A wind farm includes one or more wind turbines for producing electricity for an electrical grid. Each of the wind turbines generally includes sensors that monitor the operating parameters and other data at the wind turbine level. For example, the sensors may collect data related to turbine rotational speed, temperature, blade pitch, weather data, output frequency, etc. The data collected at the wind turbine is generally communicated to a Supervisory Control and Data Acquisition (SCADA) system.

The desired power generation and output frequency of the wind farm is based upon various considerations, including control performance standards and regulations, such as the North American Electrical Reliability Cooperation (NERC), and market demands. Conventional methods do not allow for constant monitoring and direct control of the power generation and output frequency of the wind farm based on the collected data in a closed loop.

Thus, there is a need for methods and systems for controlling wind farm output frequency through a closed-loop interface with a wind farm's existing SCADA system.

### SUMMARY

The present disclosure generally relates to methods and systems for controlling the output frequency of a wind farm by providing instructions for adjusting wind farm output frequency from a frequency controller to an Active Power (AP) Controller in an existing SCADA system. More specifically, the method generally includes receiving frequency data of a plurality of wind turbines collected at a Point of Interconnection (POI) of a wind farm, calculating an error value based on a comparison of the frequency data to a predetermined frequency set point, and determining whether to increase, decrease, or not affect an output frequency of the wind farm based on analysis of the calculated error value.

According to the disclosure, a method for controlling wind farm output frequency includes receiving frequency data of a plurality of wind turbines collected at a Point of Interconnection of a wind farm, calculating an error value based on a comparison of the frequency data to a predetermined frequency set point, and determining whether to increase, decrease, or not affect an output frequency of the wind farm based on analysis of the calculated error value.

According to the disclosure, a non-transitory computer-readable medium includes instructions which, when executed by one or more processors performs an operation. The operation includes receiving frequency data of a plurality of wind turbines collected at a Point of Interconnection of a wind farm, calculating an error value based on a comparison of the frequency data to a predetermined frequency set point, and determining whether to increase, decrease, or not affect an output frequency of the wind farm based on analysis of the calculated error value.

According to the disclosure, system includes a processor and a memory storing instructions which, when executed by the processor, performs an operation. The operation includes receiving frequency data of a plurality of wind turbines collected at a Point of Interconnection of a wind farm, calculating an error value based on a comparison of the frequency data to a predetermined frequency set point, and determining whether to increase, decrease, or not affect an output frequency of the wind farm based on analysis of the calculated error value.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 is a block diagram of a frequency control system according to the disclosure.

FIG. 2 is a block diagram of the frequency controller of FIG. 1 according to the disclosure.

FIG. 3 is a flow chart of a method for controlling the output frequency of a wind farm according to the disclosure.

FIG. 4 is a data analysis system for wind turbine and wind farm data according to the disclosure.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The present disclosure generally relates to methods and systems for controlling the output frequency of a wind farm by providing instructions for adjusting wind farm output frequency from a frequency controller to an Active Power (AP) Controller in an existing SCADA system. More specifically, the method generally includes receiving frequency data of a plurality of wind turbines collected at a Point of Interconnection (POI) of a wind farm, calculating an error value based on a comparison of the frequency data to a predetermined frequency set point, determining whether to increase, decrease, or not affect an output frequency of the wind farm based on analysis of the calculated error value, and transmitting to an AP controller the determination whether to increase, decrease, or not affect the output frequency.

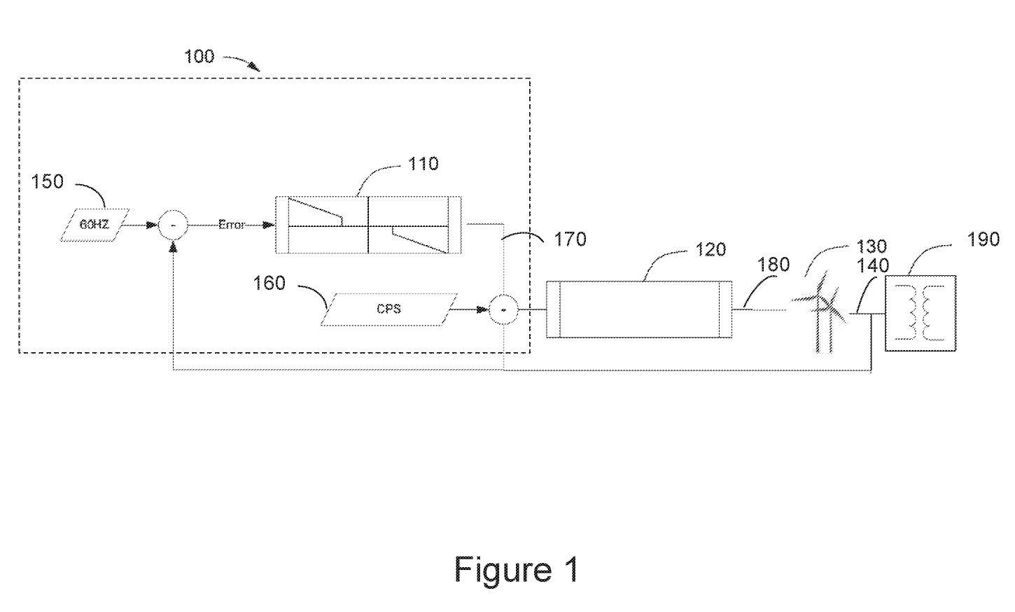

FIG. 1 is a block diagram of a frequency control system 100 according to the disclosure. A frequency controller 110 interfaces with an AP controller 120 via a wired and/or wireless network connection 170. The AP controller 120 may be newly added to or may be integrated in an existing SCADA system (not pictured) via a wired and/or wireless network connection. The AP controller 120 interfaces with one or more wind turbines of a wind farm 130 via a wired and/or wireless network connection 180. The AP controller 120 operates with the existing SCADA system and receives input from the frequency controller 110. Signaling between the frequency controller 110 and AP controller 120, as well as signaling between the AP controller 120 and the one or more wind turbines of the wind farm 130, may be transmitted, for example, according to the Modbus Profibus protocols, or any other communications protocol.

In operation, the wind farm 130 generates electricity, which is delivered to an electrical grid 190 at a POI 140. The POI 140 is the point at which the wind farm outputs power to the electrical grid 190 for transmission. During power generation, one or more sensors, installed in the one or more wind turbines of the wind farm 130, collect operational data at the wind turbine level, such as wind speed, weather data, or other related operational data, and transmit the collected data to the AP controller 120. The AP controller 120 uses the received operational data to control the active power of the one or more wind turbines of the wind farm 130. According to the disclosure, the frequency controller 110 is provided to interface with the existing AP controller 120 to control the output frequency of the wind farm 130 at the POI 140.

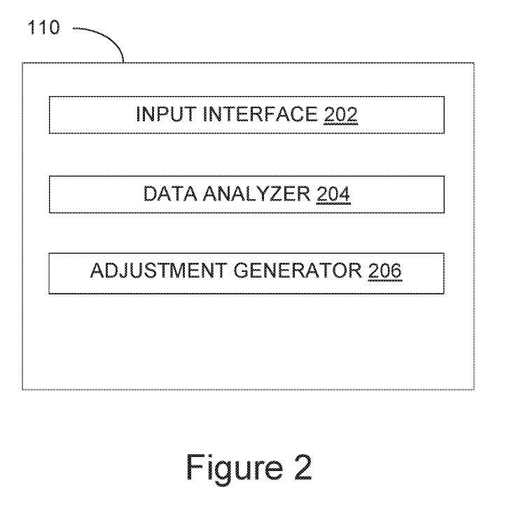

FIG. 2 is a block diagram of the frequency controller 110 of the frequency control system 100 according to the disclosure. As illustrated, the frequency controller 110 includes an input interface 202, a data analyzer 204, and an adjustment generator 206. The input interface 202 is generally configured to receive data from the wind farm 130, such as active power and output frequency data, via a wired and/or wireless network connection. Additionally, the input interface 202 is configured to receive data from external sources, such as a user, via a wired and/or wireless network connection. Even further, the frequency controller 110 is generally configured to receive data from an electrical grid 190. The data analyzer 204 is configured to analyze the data collected from the wind farm 130 or the electrical grid 190, and/or the data input by the user to calculate an error value. The adjustment generator 206 is generally configured to analyze the calculated error value and generate determinations to increase, decrease, or not affect the output frequency of the wind farm 130, which may then be transmitted to the AP controller 120.

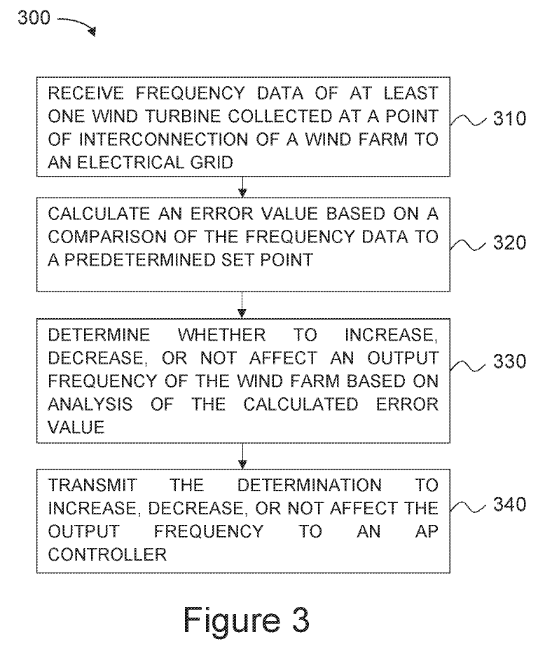

FIG. 3 is a flow chart of a method 300 for controlling the output frequency of a wind farm according to the disclosure. The method 300 begins at operation 310 where the frequency controller 110 receives frequency data of a plurality of wind turbines collected at the POI 140 of the wind farm 130 via the input interface 202. The frequency data is collected at the POI 140 as it is the point at which the wind farm 130 delivers energy to an electrical grid 190. Moreover, it is advantageous to collect the data at the POI 140 because it is the point at which power is output to the electrical grid 190 and can be monitored for compliance with, for example, regulatory restrictions and market demand. The data collected at the POI 140 may also include, but is not limited to, active power data. The data collected is then delivered to the frequency controller 110.

In addition, the frequency controller 110 also receives frequency set point data. More specifically, a user generally inputs a frequency set point 150 into the frequency controller 110. The frequency set point 150 generally corresponds to the desired output frequency of the wind farm 130. The user can evaluate at least regulatory provisions and market demands to determine which frequency set point 150 to provide to the frequency controller 110. In one example, the frequency set point 150 is 60 hertz (Hz) for 110-120 volts of alternating current (VAC) power generation or 50 Hz for 220-240 VAC power generation.

The frequency controller 110 also receives curtailment scheme data 160, such as from Qualified Scheduling Entities (QSEs), from the electrical grid 190. Curtailment scheme data 160 includes information which generally necessitates shutting down the wind farm or decreasing active power and output frequency to mitigate issues associated with energy pricing, turbine loading, exportation to the electrical grid, weather conditions, or other bulk power or grid planning technical or economic considerations. Receiving curtailment scheme data 160 is an optional function of the frequency controller 110. Receiving curtailment scheme data 160 is not necessary to perform methods according to the disclosure.

At operation 320, the frequency controller 110 calculates an error value based on a comparison of the frequency data to the predetermined frequency set point via the data analyzer 204. More specifically, the data analyzer 204 may store the collected data as well as the frequency set point 150, and then perform calculations to determine a difference between the collected data and the frequency set point 150, or vice versa.

At operation 330, the frequency controller 110 determines whether to increase, decrease, or not affect an output frequency of the wind farm based on analysis of the calculated error value. In one example, the calculated error value may be a positive value such that the output frequency at the POI 140 is below the frequency set point 150, or optimal value. In this example, the frequency controller 110 generally determines to decrease the output frequency of the wind farm, and causes the AP controller 120 to decrease the output frequency of the wind farm 130 by a calculated amount. In this example, the frequency controller 110 may alternatively determine to cause the AP controller 120 to shut down the wind farm 130. In another example, the calculated error value may be a negative value such that the output frequency at the POI 140 is above the frequency set point 150, or optimal value. In this example, the frequency controller 110 generally determines to cause the AP controller 120 to increase the output frequency of the wind farm 130 by a calculated amount. The determinations may be further based on curtailment scheme data 160, a curtailment signal, indicating a maximum amount of power output from the wind farm 130, which has been received from the electrical grid 190.

Determining whether to increase, decrease, or not affect an output frequency of the wind farm is performed when a number of over-frequency or under-frequency events exceeds a threshold. This allows for outlier occurrences of output frequency deviations to be ignored. In one example, determining whether to increase, decrease, or not affect an output frequency of the wind farm is performed upon the determination that the number of over-frequency or under-frequency events exceeds the threshold. If the number of over-frequency or under-frequency events is less than the threshold, the operation 330 of determining whether to increase, decrease, or not affect an output frequency of the wind farm may not be invoked. The threshold number of over-frequency and/or over-frequency events may also be input into the frequency controller 110 by the user. Determining whether to increase, decrease, or not affect an output frequency of the wind farm may also be based on an indication that the wind farm is not in a power generation ramping state.

At operation 340, the frequency controller 110 transmits the determination to the output frequency to the AP controller 120. Transmitting the determination the output frequency to the AP controller 120 may further cause the AP controller to undertake one or more actions to adjust the output frequency of the wind farm. The AP controller 120, which is generally an existing component of the wind farm's SCADA system, may then adjust the output frequency of the wind farm 130. The AP controller 120 may adjust the output frequency in any suitable manner in accordance with the pre-established configuration of the SCADA system. For example, the AP controller 120 may adjust the rotational speed of one or more wind turbines of the wind farm 130. In another example, the AP controller 120 may take one or more wind turbines of the wind farm 130 offline. In yet another example, the AP controller 120 may adjust the pitch of the fan blades of the one or more wind turbines of the wind farm 130 to adjust the power generated by the one or more wind turbines.

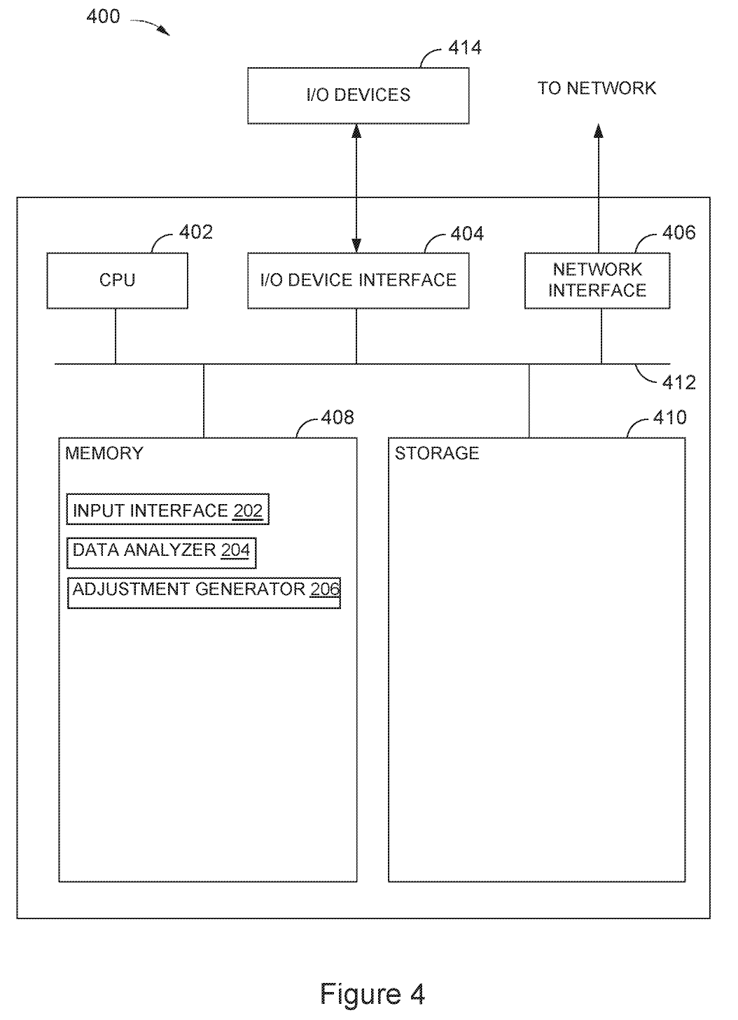

FIG. 4 is a data analysis system 400 for wind turbine and wind farm data according to the disclosure. The data analysis system 400 generally receives data from one or more wind turbines and analyzes the received data to generate operational parameter adjustments to be performed on one or more wind turbines in the wind farm 130, according to the disclosure. As shown, the data analysis system 400 generally includes, but is not limited to, a central processing unit (CPU) 402, one or more I/O device interfaces 404 which may allow for the connection of various I/O devices 414 to the data analysis system 400, network interface 406, a memory 408, storage 410, and an interconnect 412.

CPU 402 may retrieve and execute programming instructions stored in the memory 408. Similarly, the CPU 402 may retrieve and store application data residing in the memory 408. The interconnect 412 transmits programming instructions and application data, among the CPU 402, I/O device interface 404, network interface 406, memory 408, and storage 410. CPU 402 is included to be representative of a single CPU, multiple CPUs, a single CPU having multiple processing cores, and the like. Additionally, the memory 408 is included to be representative of a random access memory. Furthermore, the storage 410 may be a disk drive. Although shown as a single unit, the storage 410 may be a combination of fixed and/or removable storage devices, such as fixed disc drives, fixed solid state drives, removable memory cards or optical storage, network attached storage (NAS), or a storage area-network (SAN). In some cases, a number fixed storage devices may be combined into a logical storage device to provide fault tolerance for storage 410.

The memory 408 generally includes the executing components of FIG. 2, including the input interface 202, the data analyzer 204, and the adjustment generator 206. As described in FIG. 2, the input interface 202 is generally configured to receive data from the wind farm 130, such as active power and output frequency data, via a wired and/or wireless network connection. Additionally, the input interface 202 is configured to receive data from a user via a wired and/or wireless network connection. Even further, the frequency controller 110 is generally configured to receive data from an electrical grid 190. The data analyzer 204 is configured to analyze the data collected from the wind farm 130 or the electrical grid 190, and/or the data input by the user to calculate an error value. The adjustment generator 206 is generally configured to analyze the calculated error value and generate potential adjustments to the output frequency of the wind farm 130, which may then be transmitted to the AP controller 120. The memory 408 generally includes instructions which, when executed by the processor, performs one or more operations, for example, the operations of method 300, including but not limited to, receiving frequency data of a plurality of wind turbines collected at a Point of Interconnection of a wind farm, calculating an error value based on a comparison of the frequency data to a predetermined frequency set point, determining whether to increase, decrease, or not affect an output frequency of the wind farm based on analysis of the calculated error value, and transmitting to an AP controller the determination whether to increase, decrease, or not affect the output frequency.

The methods and systems described herein advantageously provide for direct control of wind farm output frequency in a closed loop by providing a frequency controller that interfaces with the AP controller of the wind farm's existing SCADA system. More particularly, the frequency controller receives output frequency data from the POI between the wind farm and the electrical grid, compares the data to a frequency set point to calculate an error value, utilizes the error value to determine whether to increase, decrease, or not affect output frequency of the wind farm, and transmits the one or more determinations to wind farm's existing AP controller. The AP controller can then adjust the output frequency of the wind farm by the methods for which the AP controller is already configured, or any other suitable method. The described closed-loop wind farm frequency control methods and systems allow for constant monitoring for deviations from a predetermined frequency, and automatic, or nearly automatic, frequency adjustments when such deviations are detected. Moreover, since the frequency controller can be implemented to interface with an existing SCADA system, the improved frequency control methods and systems can be efficiently incorporated into an existing wind farm.

As will be appreciated by one skilled in the art, the embodiments disclosed herein may be embodied as a system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects may take the form of a computer program product embodied in one or more computer readable medium(s) having computer readable program code embodied thereon. Program code embodied on a computer readable medium may be transmitted using any appropriate medium, including but not limited to wireless, wireline, optical fiber cable, RF, etc., or any suitable combination of the foregoing.

Aspects of the present disclosure are described above with reference to flowchart illustrations and/or block diagrams of methods, apparatus (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The flowchart and block diagrams in the Figures illustrate the architecture, functionality, and operation of possible implementations of systems, methods, and non-transitory computer-readable medium according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the foregoing is directed to embodiments of the present disclosure, other and further embodiments of the disclosure may be devised without departing from the basic scope thereof, and the scope thereof is determined by the claims that follow.

What is claimed is:

1. A method for controlling wind farm output frequency, comprising:
receiving frequency data of a plurality of wind turbines collected at a Point of Interconnection of a wind farm;
calculating an error value based on a comparison of the frequency data to a predetermined frequency set point; and
determining whether to increase, decrease, or not affect an output frequency of the wind farm based on analysis of the calculated error value.

2. The method of claim 1, further comprising transmitting to an AP controller the determination whether to increase, decrease, or not affect the output frequency, wherein transmitting the determination whether to increase, decrease, or not affect the output frequency causes the AP controller to undertake one or more actions to adjust the output frequency of the wind farm.

3. The method of claim 1, wherein determining to decrease the output frequency is based on the error value indicating the received frequency data exceeds the frequency set point.

4. The method of claim 1, wherein determining to increase the output frequency is based on the error value indicating the received frequency data is less than the frequency set point.

5. The method of claim 1, wherein determining whether to increase, decrease, or not affect an output frequency of the wind farm is based on a curtailment signal indicating a maximum amount of power output from the wind farm.

6. The method of claim 1, wherein determining whether to increase, decrease, or not affect an output frequency of the wind farm further comprises:
determining whether a number of over-frequency or under-frequency events exceeds a threshold.

7. The method of claim 2, wherein the AP controller controls frequency output individually for each wind turbine.

8. A non-transitory computer-readable medium having instructions stored thereon, which when executed by one or more processors, performs an operation, the operation comprising:
receiving frequency data of a plurality of wind turbines collected at a Point of Interconnection of a wind farm;
calculating an error value based on a comparison of the frequency data to a predetermined frequency set point; and
determining whether to increase, decrease, or not affect an output frequency of the wind farm based on analysis of the calculated error value.

9. The non-transitory computer-readable medium of claim 8, further comprising transmitting to an AP controller the determination whether to increase, decrease, or not affect the output frequency, wherein transmitting the determination whether to increase, decrease, or not affect the output frequency causes the AP controller to undertake one or more actions to adjust the output frequency of the wind farm.

10. The non-transitory computer-readable medium of claim 8, wherein determining to decrease the output frequency is based on the error value indicating the received frequency data exceeds the frequency set point.

11. The non-transitory computer-readable medium of claim 8, wherein determining to increase the output frequency is based on the error value indicating the received frequency data is less than the frequency set point.

12. The non-transitory computer-readable medium of claim 8, wherein determining whether to increase, decrease, or not affect an output frequency of the wind farm is based on a curtailment signal indicating a maximum amount of power output from the wind farm.

13. The non-transitory computer-readable medium of claim 8, wherein determining whether to increase, decrease, or not affect an output frequency of the wind farm further comprises:
determining whether a number of over-frequency or under-frequency events exceeds a threshold.

14. The non-transitory computer-readable medium of claim 9, wherein the AP controller controls frequency output individually for each wind turbine.

15. A system comprising:
a processor; and
a memory storing instructions which, when executed by the processor, performs an operation, the operation comprising:
receiving frequency data of a plurality of wind turbines collected at a Point of Interconnection of a wind farm;
calculating an error value based on a comparison of the frequency data to a predetermined frequency set point; and
determining whether to increase, decrease, or not affect an output frequency of the wind farm based on analysis of the calculated error value.

16. The system of claim 15, further comprising transmitting to an AP controller the determination whether to increase, decrease, or not affect the output frequency, wherein transmitting the determination whether to increase, decrease, or not affect the output frequency causes the AP controller to undertake one or more actions to adjust the output frequency of the wind farm.

17. The system of claim 15, wherein determining to decrease the output frequency is based on the error value indicating the received frequency data exceeds the frequency set point.

18. The system of claim 15, wherein determining to increase the output frequency is based on the error value indicating the received frequency data is less than the frequency set point.

19. The system of claim 15, wherein the i determining whether to increase, decrease, or not affect an output frequency of the wind farm further comprises:
determining whether a number of over-frequency or under-frequency events exceeds a threshold.

20. The system of claim 16, wherein the AP controller controls frequency output individually for each wind turbine.
